(19) United States
(12) Patent Application Publication
(10) Pub. No.: US 2025/0336129 A1
(43) Pub. Date: Oct. 30, 2025

(54) GENERATING VISUALIZATIONS USING ARTIFICIAL INTELLIGENCE OR MACHINE LEARNING

(71) Applicant: MicroStrategy Incorporated, Vienna, VA (US)

(72) Inventors: Jingbin Zhang, Hangzhou (CN); Yaochun Li, Hangzhou (CN); Ying Huang, Hangzhou (CN); Sheng Zhao, Great Falls, VA (US); Ananya Ojha, Dunn Loring, VA (US); Jeffrey Clay Courcelle, Atkinson, NH (US)

(21) Appl. No.: 19/193,400

(22) Filed: Apr. 29, 2025

Related U.S. Application Data
(60) Provisional application No. 63/639,983, filed on Apr. 29, 2024.

(51) Int. Cl. G06T 11/60; G06F 16/26

(52) U.S. Cl. CPC G06T 11/60; G06F 16/26; G06T 2200/24

(57) ABSTRACT

Methods, systems, and apparatus, including computer programs encoded on computer-storage media, for managing artificial intelligence chatbots. In some implementations, a system identifies a data source with which to generate a visualization. The system generates a request for an artificial intelligence or machine learning (AI/ML) model to generate code or instructions to retrieve from the data source data that satisfies one or more criteria. The system sends the request and receives code or instructions that the AI/ML model generated in response to the request. The system determines one or more visualization properties based on the code or instructions that the AI/ML model generated in response to the request. The system provides visualization data for a visualization of data from the data source presented according to the one or more visualization properties.

### CROSS-REFERENCE TO RELATED APPLICATIONS

This application claims the benefit of priority to U.S. Provisional Patent Application No. 63/639,983, filed on Apr. 29, 2024, the entire contents of which is hereby incorporated by reference herein.

### BACKGROUND

The present specification relates to techniques for generating visualizations using artificial intelligence and machine learning.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users.

### SUMMARY

In some implementations, a computer system uses artificial intelligence or machine learning (AI/ML) models to generate data visualizations, such as charts, graphs, maps, and so on. The system can generate accurate, high-quality visualizations using a process that leverages the capabilities of AI/ML models, such as large language models (LLMs), as well as the capabilities of data processing systems, such as database management systems. For each visualization generated, the system can use multiple interactions to combine repeatable, accurate data retrieval of a data processing system with the generative and inference capabilities of an AI/ML model.

For example, the system can provide an AI/ML model information about a data set (e.g., a data model for the data set, a data schema for the data set, metadata for the data set, sample data from the data set, etc.) and ask the AI/ML model to generate instructions or code that, when executed, would retrieve the subset of data from the data set that should be shown in a visualization. The system then examines the data retrieval instructions or code generated by the AI/ML model to translate those instructions into as set of characteristics that the visualization should have. For example, the system can use a program or set of rules to extract from the data retrieval instructions or code to a set of parameter values or features that define the visualization, e.g., a visualization type (e.g., line graph, bar chart, pie chart, heatmap, geographical map, etc.), data labels, assignment of values or data series to axes or visualization regions, and so on. The system also uses the data retrieval instructions or code generated by the AI/ML model to retrieve data using the data processing system and the system uses the retrieved data to generate the visualization. As a result, the system can generate a visualization of data based on the ability of the AI/ML model to understand natural language understanding and infer relationships, along with the reliable and repeatable results from a data processing system such as a database management system.

Many AI/ML models, such as LLMs, have demonstrated a strong capability for generating text in response to input prompts, with the ability to process natural language input and provide useful text output in various forms. Some AI/ML models have demonstrated strong capabilities to generate software code or other computer instructions that follows the rules or conventions of a programming language, which may be a data manipulation language (DML) or other programming language. In at least some cases, the nature of programming languages facilitates AI/ML models learning these types of outputs, because programming languages often feature the use of predefined terms, relationships, and syntax. As a result, examples of code in training data can show patterns that follow the rules of the programming language and allow those patterns to be learned well by the AI/ML models. By contrast, many AI/ML models that generate images or other visual content produce outputs that can be inconsistent, varying widely in style and characteristics from one request to the next. In addition, AI/ML models for generating images often do not reliably represent values and proportions accurately as is typically expected for data visualizations.

As discussed further below, the present techniques show how visualizations can be generated using the strengths of AI/ML models to interpret natural language and express relationships in a clear manner through data retrieval code or instructions. Rather than asking an AI/ML model to generate a visualization, the system can request that the AI/ML model generate code or instructions to retrieve the data that would be represented in the visualization. A separate, non-AI/ML module can extract the properties of the visualization, and the system can obtain the appropriate data and generate a visualization with the properties determined. This technique can provide various advantages. For example, the AI/ML model is used for functions that it performs well (e.g., natural language interpretation, code generation), instead of for functions that are likely to give highly variable or inconsistent results (e.g., image generation). The AI/ML model can be used to generate an output using a standardized type of code, such as a structured query language (SQL) statement, Python code, etc., for which there is a large set of training data and existing AI/ML models have already exist with the output generation capability. In many cases, an existing model that is capable of generating SQL can be used, without the need to gather training data or expend the significant resources for training an AI/ML model to perform a customized task.

Using the AI/ML model to produce output in a standardized format such as SQL limits ambiguity and expresses relationships in a domain with clear rules and patterns, and much less variation than general text responses. In addition, asking the AI/ML model to specify the data to be obtained focuses the AI/ML model on the characteristics of the data set, and separates the visual design of the visualization. For example, the system is not dependent on the AI/ML model having been trained with appropriate examples of visualizations. The system, in translating from data retrieval code or instructions to visualization properties, can provide consistent styles, formatting, and visual characteristics across different user requests and data sets, which is often challenging for many AI/ML models. The use of a standardized format for the AI/ML model output also facilitates the use of different AI/ML models. Even if the particular AI/ML model is switched or updated, the system can still translate the code or instructions to visualization properties and also provide consistent visual characteristics and reliable accuracy for visualizations across many different AI/ML models.

In general, the system can support interactive applications where processing tasks for responding to a user prompt are split between non-AI/ML or non-probabilistic data processing systems (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a LLM, to generate content to present in a response to the user. This system can combine the strengths of AI/ML models and non-AI/ML processing systems to provide responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. This may especially be the case when what is needed is an accurate representation of data from a particular data set that is not in the model's training data, and the data set is often larger than the model's context window. In some cases, AI/ML models provide content that includes hallucinations or content that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the system can provide visualizations as responses of chatbots and other interactive applications, in a way that combines the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data. The visualizations that are provided can be created with properties determined from AI/ML model output, but with the actual visual characteristics generated separate from the AI/ML model based on data retrieved from the source data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., a data model, data schema, metadata indicating a list of logical objects such as types of metrics and attributes, semantic meaning of the data columns, etc.). In some cases, sample data (e.g., a limited sampling of the data set, or fictitious examples that illustrate the type of content in the dataset without revealing the actual values and records) may be provided. In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers. With the system performing discrete operations leveraging AI/ML models, separate from the core querying of an enterprise's proprietary datasets, the chatbots can be more easily integrated with the processing capabilities of third-party systems.

In one general aspect, a method performed by one or more computers includes: identifying, by the one or more computers, a data source with which to generate a visualization and one or more criteria for selecting data from the data source to be represented in the visualization; generating, by the one or more computers, a request for an artificial intelligence or machine learning (AI/ML) model to generate code or instructions to retrieve from the data source data that satisfies the one or more criteria; sending, by the one or more computers, the request to be processed by the AI/ML model; receiving, by the one or more computers, code or instructions that the AI/ML model generated in response to the request; determining, by the one or more computers, one or more visualization properties for the visualization based on the code or instructions that the AI/ML model generated in response to the request; and providing, by the one or more computers, visualization data for display, wherein the visualization data is displayable to present data retrieved from the data source based on the code or instructions that the AI/ML model generated, with the retrieved data being presented according to the one or more visualization properties determined based on the code or instructions that the AI/ML model generated.

In some implementations, the request is a request for a large language model (LLM) to generate a structured query language (SQL) statement; the received code or instructions comprises a generated SQL statement; and the one or more parameters for the visualization are determined based on analysis of the SQL statement.

In some implementations, the one or more criteria comprises a user prompt comprising text that includes a natural language statement from a user; and generating the request comprises generating a request to generate code or instructions to retrieve and/or calculate values specified by the natural language statement in the user prompt.

In some implementations, the user prompt is input to a chatbot and the visualization data is provided as output of the chatbot in response to the user prompt.

In some implementations, the one or more criteria comprises information derived from an existing visualization.

In some implementations, the one or more criteria includes one or more criteria determined based on a document or user interface that is active on a client device.

In some implementations, the method includes: translating the code or instructions generated by the AI/ML model to a set of data processing instructions for a database system; and retrieving the data represented in the visualization from the database system based on the generated data processing instructions.

In some implementations, the visualization properties determined based on the code or instructions from the AI/ML model specify at least one of a visualization type, a label for the visualization or a portion of the visualization, a data series to be represented in the visualization, a layout of the visualization, or formatting of the visualization.

In some implementations, the data source comprises one or more data tables, and wherein the code or instructions specify one or more rows of data to retrieve and calculations using data from the one or more rows that generate values to be represented in the visualization.

In some implementations, the request includes a data model or data schema for the data source; and the code or instructions generated by the AI/ML model includes instructions, using references to data elements specified in the data model or data schema, to retrieve a particular subset of data from the data source that satisfies the particular set of criteria.

In another general aspect, a method performed by one or more computers includes: sending, by the one or more computers, a request for one or more artificial intelligence and/or machine learning (AI/ML) models to generate code or instructions that specify criteria for retrieving data from a data source; receiving, by the one or more computers, code or instructions generated by the one or more AI/ML models in response to the request; determining, by the one or more computers, data visualization parameters based on the code or instructions; generating, by the one or more computers, results from the data source based on the generated code or instructions; and providing, by the one or more computers, user interface data for presentation, wherein the user interface data is displayable to provide a data visualization that illustrates the results from the data source according to the determined data visualization parameters.

In some implementations, the data visualization parameters specify at least one of a visualization type, a data label, an independent variable, a dependent variable, a data range, a level of precision or granularity, a scale or size, formatting properties, or an assignment of values or data series to axes or visualization regions.

In some implementations, the one or more AI/ML models generate the code or instructions based at least in part on a data model or data schema for the data source; and determining the data visualization parameters based on the code or instructions comprises: identifying data objects from the data model or data schema that are referenced in the code or instructions; and selecting a type of visualization based on a number of data objects identified or types of data provided by the identified data objects.

In some implementations, the selected type of visualization is a chart or graph, and wherein determining the data visualization parameters based on the code or instructions comprises selecting which types of data to represent for axes of the chart or graph based on the code or instructions.

In some implementations, sending the request comprises providing a data model or data schema for the data source to the one or more AI/ML models; and the code or instructions express a mapping of concepts expressed in natural language text in the request to data objects from the data model or data schema for the data source.

In some implementations, receiving a prompt from a user, wherein the request is configured to request code or instructions that specify criteria for retrieving data for a response to the prompt from the user.

In some implementations, the method includes generating a text response to the prompt from the user, wherein the text response includes text generated by the one or more AI/ML models based on the prompt from the user and the results from the data set; and providing the data visualization for presentation with the text response to the prompt.

In some implementations, the method includes identifying a context of a user interface of a client device; and the request is generated based on the context of the user interface.

In some implementations, identifying the context of the user interface comprises identifying one or more topics or data objects and one or more data sources based on content or state of the user interface; and the request is generated to request data about the one or more topics or data objects from the one or more data sources.

In some implementations, the one or more AI/ML models comprise a large language model (LLM).

In some implementations, the code or instructions comprise a structured query language (SQL) statement.

In some implementations, the code or instructions comprise executable or interpretable code.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIGS. 1A-1B are diagrams showing examples of a system for generating visualizations using artificial intelligence or machine learning.

FIGS. 2-4 are diagrams showing examples of generating visualizations using artificial intelligence or machine learning.

FIGS. 5A-5D show example user interfaces showing functionality for showing natural language insight derived from visualization data and other content.

Like reference numbers and designations in the various drawings indicate like elements.

### DETAILED DESCRIPTION

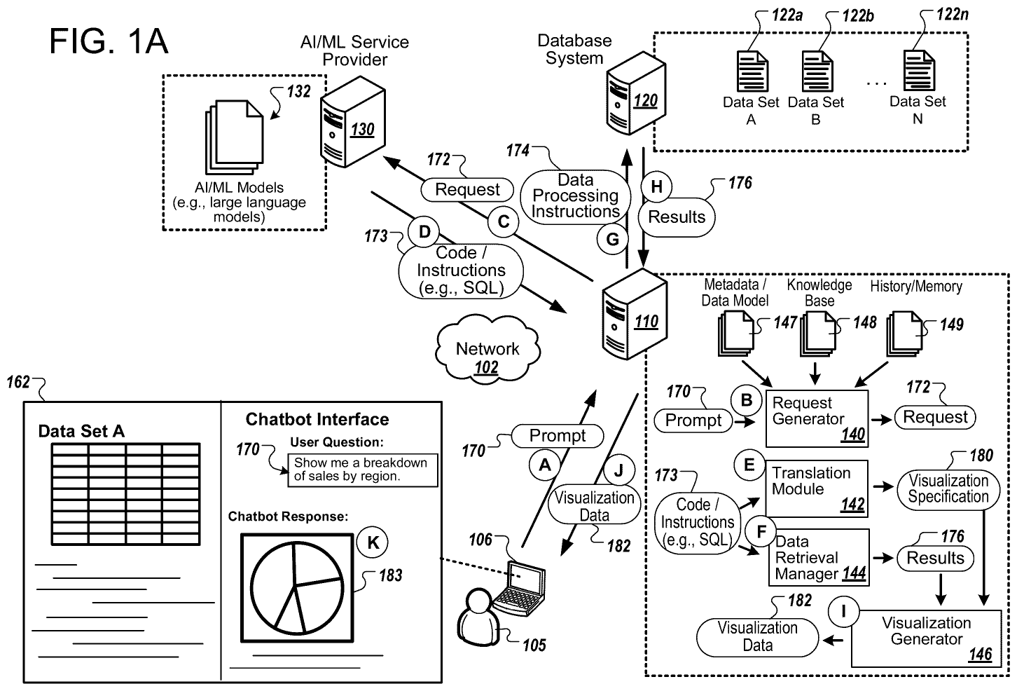

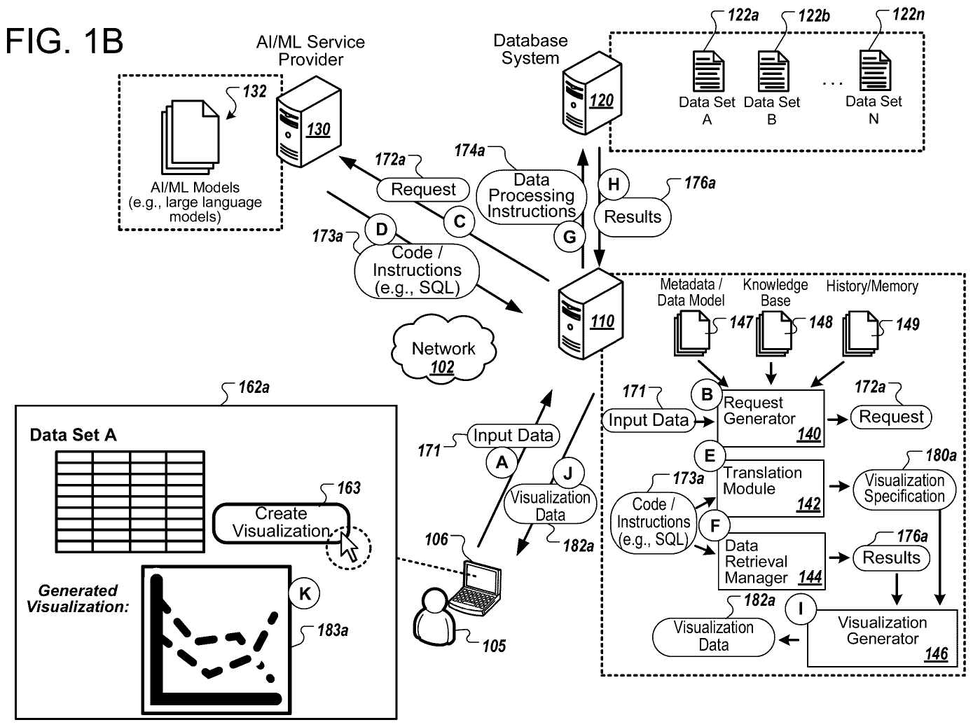

FIG. 1A is a diagram showing an example of a system 100 for generating visualizations using artificial intelligence or machine learning. The system 100 includes a computer system 110, a database system 120, and an AI/ML service provider 130. The elements of the system 100 communicate over a network 102, such as the Internet. The computer system 110 coordinates a variety of operations to provide and manage access to chatbots and other AI/ML applications that can provide data visualizations. In the example, a user 105 interacts with a user interface 162 using a user device 106. In response to user interaction, the computer system 110 obtains data from the AI/ML service provider 130 and the database system 120 to obtain information used to generate a visualization 183 presented on the user interface 162. The example of FIG. 1A includes stages (A) to (K), which represent various operations and a flow of data, and which can occur in the order illustrated or in a different order.

The computer system 110 can be implemented using one or more servers, such as one or more cloud computing systems, one or more on-premises servers, etc. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as tables, data cubes, or other forms.

Different users have access to different datasets 122a-122n and chatbots, depending on their roles, permissions, etc. The user 105 authenticates, so that the user's identity is determined and the user's permissions can be determined. Based on the user's identity, permissions, and access control data (e.g., access control lists specifying authorized users), the computer system 110 manages access of the user to chatbots and other AI/ML applications.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

As an overview, in the example of FIG. 1A, a user 105 interacts with a chatbot through a user interface 162, and the computer system 110 manages a process of generating and providing a visualization to the user 105. For example, after the user 105 enters a user prompt 170 and the user's device 106 sends the prompt 170 to the computer system 110 for processing. The computer system 110 receives the prompt 170 and begins a series of interactions used to generate a visualization based on the prompt 170. The process of generating the visualization includes the computer system 110 requesting that an AI/ML model 132 generate code or instructions for retrieving, from a particular data set 122a, data to be represented in the visualization to be generated. Once the AI/ML model 132 provides the requested code or instructions 173, the computer system 110 extracts information from the code or instructions 173 to determine properties of the visualization that are shown as a visualization specification 180. The computer system 110 also converts the code or instructions 173 into a set of data processing instructions 174 that the database system 120 uses to retrieve the data to be shown in the visualization. The computer system 110 then uses the visualization specification 180 and the results 176 from the database system 120 to generate visualization data 182 that is sent to the user device 106 for display.

In further detail, in stage (A), the user 105 enters a prompt 170 in a user interface 162 as input to a chatbot, and the prompt 170 is sent to the computer system 110 over the network 102. The user device 106 of the user 105 displays a user interface 162 that shows information about data set 122a, labeled “Data Set A.” For example, the user interface 162 may show a document, dashboard, file manager, or other type of user interface content. The user interface 162 includes a region, such as a panel on the side, for the user 105 to have a conversation with a chatbot. The chatbot interface, like the rest of the user interface 162, can be a web page, a web application, a native application, or other functionality.

In the example, the user 105 entered “show me a breakdown of sales by region” as the prompt 170. The user device 106 and/or the computer system 110 can determine which data set to use in generating the visualization in any of various ways. For example, the chatbot may be a chatbot that has been created to or designated to be used for answering questions about the particular data set 122a, so the chatbot is pre-configured to use the data set 122a. As another example, the computer system 110 and/or the chatbot may receive context information about whichever data set 122a-122n is currently active and relevant to the user interface 162. For example, the data set 122a can be identified based on being referenced in the user interface 162, for being referenced in content or metadata for a document shown in the user interface 162, for being the source of data shown in another visualization in the user interface 162, for being used to generate content shown in the user interface 162, and so on. As another example, the user prompt 170 may be provided as part of a longer conversation with the chatbot, and previous interactions with the chatbot (e.g., conversation history, for the current session or previous sessions) may establish that the data set 122a is the data set relevant to the conversation. Other options are also possible. For example, the computer system 110 or the chatbot can search among data sets that the user 105 is authorized to access and determine which data set(s) are most relevant to terms of the prompt 170, such as “sales.” Similarly, the computer system 110 may store usage data for the user 105 that indicates which data sets 122a-122n are most frequently or most recently accessed by the user 105 in any of various ways (e.g., the user reading, writing, editing, sharing, querying, interacting with chatbots, etc.), and the computer system 110 can select which data set is most likely based on the usage data.

In stage (B), the computer system 110 generates a request 172 to the AI/ML service provider 130, requesting for an AI/ML model 132 to generate code or instructions for retrieving the data to be shown in a data visualization. In the example, the computer system 110 does not request for the AI/ML model 132 to provide the values to be depicted in the visualization or even for the AI/ML model 132 to describe the visualization. Instead, the request 172 asks for code or instructions that, when executed, would retrieve and/or calculate the data that would be shown in the visualization. For example, the request 172 asks for the AI/ML model 132 to provide instructions in a standardized format, such as a SQL statement, that specifies a portion of the data set 122a to be retrieved and/or operations to calculate values from that data. As discussed below, the computer system 110 will later determine the visual properties of the visualization and obtain the data to be represented, without the AI/ML model 132 needing to provide that data or describe the visualization.

The computer system 110 is illustrated to include a request generator 140, for example, a software module that generates the request 172 based on the prompt 170. The natural language text of the user prompt 170 can provide one or more criteria for the particular subset of data or particular values to be retrieved and ultimately illustrated in the visualization to be generated. Generating the request 172 can include generating modified text as a prompt to the AI/ML model 132, such as a LLM. For example, the text of the user prompt 170 can be supplemented and/or edited in various ways, such as to specify that data retrieval is desired for the topic of the user prompt 170, to specify a format or programming language for the output of the AI/ML model 132 (e.g., SQL, Python, etc.), to specify which data set 122a-122n data will be retrieved from, and so on. For example, for the user prompt 170 “show me a breakdown of sales by region,” the request generator 140 can create the modified prompt “Generate a SQL statement to retrieve data for a breakdown of sales by region, from Data Set A.” In the example, the request generator 140 processes the user prompt 170 to modify or replace the text calling for a visualization (e.g., “show me”) and instead provides the instruction “generate a SQL statement to retrieve data for.” The request generator 140 or other functionality of the computer system 110 can store rules, examples, or other data that specify keywords, phrases, patterns, or other text content that represents a request for a visualization, and the request generator 140 can insert a data retrieval instruction in its place.

As another example, the request generator 140 may generate an instruction to the AI/ML model 132 that includes the entire user prompt 170 unaltered, but adds additional instruction before and/or after, such as “Generate a SQL statement to retrieve data from Data Set A that would be shown in a visualization responding to the prompt ‘Show me a breakdown of sales by region.’” Many different text formats and options can be used by the request generator 140. In some implementations, the text in the request 172 can be tailored for the particular AI/ML model 132 to be interacted with, so that different request text would be generated for requests to different AI/ML models 132 (e.g., models from different sources, models with different capabilities, etc.).

The request generator 140 also generates the request 172 to include additional information to assist the AI/ML model in responding to the request 172, such as metadata or a data model 147 for the data set 122a, a knowledge base 148, and/or history or memory 149 for the chatbot. Each of these types of additional information can be provided in or with the request 172 as context that the AI/ML model 132 can use to generate data retrieval code or instructions accurately.

The data model 147 can include information about the data set(s) that the chatbot will use to respond to the request 172, without including actual data from the data set. For example, the data model 147 can include a data schema for the data set 122a. In general, the data model 147 can indicate a list of logical objects represented in the data set 122a, such as a list of the elements or components of the data set. For example, the data model 147 can indicate that the data set 122a includes logical objects such as date, customer identifier, region code, sales amount, and so on. These data objects can represent quantities or data objects that are represented in, or can be derived from, data in the data set 122a. The logical objects, such as metrics or attributes, can represent the type of data that is stored in or derived from a column of data. For example, an attribute may represent a type of data stored in a column of a data table or the result that would be obtained by applying a particular arithmetic expression to data in a column. Similarly, a metric or fact can represent the result of applying a particular aggregation function or other operation(s) to values in one or more columns of a data table. Accordingly, the data model 147 can indicate the attributes and metrics that are available for the AI/ML model 132 to work with, and potentially additional attributes or metrics that can be generated or operations that are available for the database system 120 to create a new attributes or metrics.

In some cases, the data model 147 can indicate, through the logical objects identified, types of data from tables, columns, and other elements that make up the data set 122a, in addition to or instead of the semantic meanings and/or relationships among these elements of the data set 122a. For example, the data model 147 can indicate that the data set 122a includes set of data named “sales_table,” that includes a metric named “sales_amount” that indicates amounts of sales and another attribute named “region” that indicates the region in which the sale occurred. These quantities may or may not correspond directly to the structure of the data set 122a. For example, the item “sales_table” may be an actual data table of a database, or may not represent a table and instead another grouping of data. Similarly, the “sales_amount” and “region” objects may correspond to specific columns of a data table, but may alternatively represent values that can be calculated or otherwise derived from the data set 122a in another way. Providing the data model 147 can give the AI/ML model 132 a list and description of the logical objects that the database system 120 recognizes. As a result, the AI/ML model 132 can generate code or instructions that reference these logical objects that are understood by the computer system 110 and the database system 120. To the extent that the objects indicated in the data model 147 differ from the actual structure of the data set 122a, the computer system 110 and the database system 120 can use convert from the logical object names used in the data model 147 to actual data set elements and functions.

The data model 147 can indicate the names or labels for these data elements, classifications of the elements (e.g., metric, attribute, etc.), and other information. In some implementations, the data model 147 can include sample data for the data set 122a, such as a sampling of data from the data set 122a. The sample data can be fictitious example data that may be artificially synthesized to be representative of the data in the data set 122a (e.g., similar types of data), without indicating actual contents of the data set 122a. The data model 147 can be provided in any of various forms, such as a database schema from a database management system, a list or definitions of objects, components, or identifiers of the data set 122a, etc.

By providing the data model 147 with the request 172, the computer system 110 provides the AI/ML model 132 the ability to make use of the logical objects specified in the data model 147. As a result, the AI/ML model 132 can determine the types of data that would be available from the data set 122a, even without the AI/ML model 132 having any access to the data set 122a. The AI/ML model 132 can generate code or instructions (e.g., a SQL statement) that references these logical objects, with a clear set of names or other identifiers to accurately and unambiguously reference components of the data set 122a. For example, providing the data model 147 for the data set 122a, may enable the AI/ML model 132 to reference logical objects in generated SQL statements that the computer system 110 and/or database system 120 can unambiguously map the logical objects to tables and columns of the data set 122a. This allows the AI/ML model 132 to distinctly and unambiguously define criteria to specify the subset or portion of data to be retrieved from, or calculated based on, the data set 122a.

In addition, access control restrictions can be taken into account to adjust which data can be used. For example, the computer system 110 can generate the request 172 so that the AI/ML model 132 does not use or rely on portions of the data set 122a that the user 132 does not have authorization to access. For example, the data model 147 provided with the request 172 can be a modified version of the data model for the data set 122a that identifies only the logical objects or portions of the data set 122a that the user 105 is authorized to access, and excludes portions of the data set 122a that the user 105 is not authorized to access. As a result, the AI/ML model 132 will not be aware of data sets or data objects that should not be accessed on behalf of the user 105.

The knowledge base 148 can provide a mapping for the AI/ML model 132 to map words and phrases with non-standard or idiosyncratic meanings (e.g., jargon, nicknames, etc.) to definitions, descriptions, or other indications of their meaning. The knowledge base 148 can include information determined at any of multiple levels, such as at the level of an enterprise as a whole, for a department or group of individuals, or for a specific individual. Similarly, the knowledge base 148 can be one that has been created for a single chatbot or AI/ML application or one that is shared with multiple chatbots or AI/ML applications.

In some implementations, the computer system 110 enables the administrator 103 to attach one or more additional data sets to adjust the operation and output of the chatbot. For example, an additional data set can be a knowledge base 148 or data dictionary can be added. Unlike the primary data set that the user selects for the chatbot (e.g., data set 122a), the chatbot is not configured to answer questions about the additional data set or to retrieve metrics or to provide visualizations of the knowledge base 148. Instead, the knowledge base 148 can be provided to assist the chatbot in interpreting user queries and providing responses with the terminology for the user's organization. In general, the knowledge base 148 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 148 is designated for the chatbot to describe these and other internal terms. Each time the user submits a prompt, the knowledge base 148 can be provided to assist the LLM with the context that is appropriate for the company. The knowledge base 148 can provide information similar to a semantic graph, by describing entities and their relationships. In some cases, the information in the knowledge base 148 can be derived from a semantic graph 150 and then converted into text (e.g., unstructured, semi-structured, or structured) in a format that can be processed by the LLM.

In general, the knowledge base 148 or other additional data set can include data that maps terms or phrases to their meanings. In many cases, this can include semi-structured data or explanatory content, as a way to explain entities and relationships wo the AI/ML models 132. Although the knowledge base 148 may include definitions, more generally the information may include descriptions of people, roles, business units, products, and other terms that may be referenced. The administrator 103 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 148 as contextual data sets that can be applied consistently across the enterprise, for all chatbots created and used in the enterprise. Similarly, different departments within the enterprise may add their own particular contextual data sets that may supplement the enterprise-wide knowledge bases 148. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases 147 can additionally or alternatively be specified with a scope that corresponds to a computing environment, so that chatbots associated with a particular domain or server inherit the knowledge bases for that domain or server.

One of the advantages of the knowledge base 148 is consistency for many users and even for many different chatbots of an organization. The user submitting a prompt does not need to take any action to select or include the knowledge base 148 in the chatbot's processing, the chatbot automatically include the knowledge base 148 in its context for each prompt or question received. Also, because the knowledge base 148 can be shared or inherited by many chatbots within an organization, updating and maintaining the knowledge base 148 is simple. An edit to the knowledge base 148 is automatically applied to all of the chatbots associated with the organization, even if the chatbots were created by different administrators or provided to different sets of users.

In addition, the knowledge base 148 provides persistent context that is not lost from one prompt to another or from one session to another. The knowledge base content can also be implemented applied in a manner that the knowledge base 148 does not count toward the instruction token limits that the AI/ML models 132 consume for each response. Rather than counting toward the tokens for prompts and recent history, the knowledge base 148 can be accessed or provided to the AI/ML models 132 as a separate source of knowledge apart from the prompt and context, and so does not count toward the token limits of an LLM. Implementations of access to the knowledge base 148 can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 148 can be prepared as an embedding, a vector database, or other format that can be accessed by or referred to by the AI/ML models 132.

The history or memory 149 can represent any of various types of information that can be stored external to the AI/ML models 132 but captures information about previous sessions, previous conversations or previous text of the current conversation, preferences of one or more users, learning from feedback of one or more users, and so on. In some implementations, the chatbot is designed to have a long-term memory 148, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 149 for the chatbot. For example, the long-term memory 149 can store items such as definitions of terms for a particular user context, unique text elements the chatbot might encounter, and feedback from prior user interactions.

One valuable aspect of the long-term memory 149 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

The learning of the chatbot is managed by the computer system 110 and happens on an ongoing basis as users interact with the chatbot. The information learned is stored outside the LLM or other AI/ML models 132, and is stored in the long-term memory 149 designated for the chatbot. Each chatbot that is created can have its own long-term memory 149, which is updated by the interactions of its own users. Before the computer system 110 asks the stateless LLM to provide a response to a user prompt, the computer system 110 facilitates retrieval of data from the long-term memory 148, potentially to provide customized instructions or additional contextual data to accompany the user prompt and tailor the response based on what has been learned from prior interactions. The long-term memory 148 thus provides better reference data for LLM to use in guiding answer generation.

The long-term memory 149 can include business definitions of other users have specified or uploaded. In this way, the long-term memory 149 can supplement or expand on the descriptions provided in the knowledge base 148. The information can be stored and used at different levels, e.g., at the level of individual users, at the level of a department or group of users, and for an enterprise as a whole. In other words, the preferences of an individual may be learned and applied for that individual. In addition, the aggregate preferences learned for many individuals can be combined to also adjust the chatbot, to accelerate the adaptation of the chatbot to meet the needs of the user base. In some implementations, the computer system 110 can use access control lists and permissions for users to apply security policies to adjust access and appropriately set the context for each user.

In some implementations, given the user interactions or feedback received through prompt-response cycles with the user 105c and/or other users, the long-term memory 149 may include information that can clarify what users intend when they ask a question as indicated in the prompt 170. For example, the long-term memory may specify that a visualization should be included, or that data should be ordered in a particular way. In addition, the computer system 110 also stores information about the user 105c and his current context, represented as user context data 156. This user context data 156 can indicate, for example, the identity of the user, permissions of the user, a device type of the user's device 106, a location of the user, a role of the user, a department of the user, and so on. In addition, the computer system 110 stores conversation histories 157 of users that have previously interacted with the chatbot. As a result, information about previous prompts from the user 105c and previous responses, in whole or in part (e.g., in summary form) and from the current session and/or previous sessions, can be retrieved and used to supplement the prompt 170. The computer system 110 can provide the user context data 156 and conversation history 157 for the user 105 in or with the request 172, so the AI/ML model 132 can generate data processing instructions with the context of the user's situation and previous conversations, which may better explain or help disambiguate the most recent prompt 170.

In stage (C), the computer system 110 sends the request 172 to the AI/ML service provider 130. As discussed above, the request 172 can include an instruction for the AI/ML model 132 to generate code or instructions (e.g., SQL) that would retrieve, from the data set 122a, data to be represented in a visualization according to the prompt 170. For example, the request 172 specifies the data set 122a to use and the criteria (e.g., from the user prompt 170) for which data should be retrieved from the data set 122a. The request 172 also includes information about the dataset 122a, such as the data model 147, which can describe the structure and content of the data set, including items such as the names, semantic meaning, and relationships of components of the data set 122a.

As a result, the request 172 can be a request for a SQL statement or Python code that, when interpreted or executed by another system such as the database system 120, will cause the other system to retrieve and/or generate a focused subset of data (e.g., a result data set) from the data set 122a that would be shown in a visualization as requested by the user prompt 170. By requesting code or instructions, the process takes advantage of the ability of AI/ML models 132 to reliably produce high-quality code or instructions expressed in programming languages (e.g., SQL, Python, Java, HTML, XML, etc.). This often generates in a more concise and unambiguous result than more free-form text outputs. This type of request guides or constrains the AI/ML model 132 to follow the conventions of a particular programming language (which can be specified in the request 172). Programming languages are usually designed to avoid ambiguity and to promote consistency in usage of terms across many different situations. As a result, code examples often demonstrate clear usage patterns that the AI/ML models 132 can learn from and follow.

Also, by requesting that the AI/ML model 132 create the code or instructions using a standardized format, such as SQL, this greatly increases the number of different AI/ML models 132 that can be used with the system. For examples, many different LLMs may have a capability to create SQL, while models, if any, may be able to reliably generate visualizations or descriptions of visualizations. With many different options for selecting an AI/ML model 132 to create SQL, the computer system 110 has the versatility to vary which AI/ML service provider or model is used (e.g., for cost, speed, load balancing, etc.) and the robustness to change which model is used if a AI/ML service provider or model becomes unavailable.

Requesting that the AI/ML model 132 create code or instructions for data retrieval takes advantage of strengths of LLMs, such as natural language interpretation of the user's prompt 170 and ability to generate text, such as code, that follows established patterns or rules. This also constrains the constrains the form of the output to a set of code or instructions, such as SQL or another standardized representation, which allows the high-quality results to be achieved reliably.

In stage (D), the AI/ML service provider 130 uses one or more of the AI/ML models 132 to generate a response to the request 172. The AI/ML service provider 130 then sends the response, code or instructions 173 for retrieving or processing data, to the computer system 110. For example, the AI/ML service provider 130 uses the AI/ML models 132 to generate, as the code or instructions 173, a SQL statement that, when executed by the database system 120, will retrieve and/or generate the data needed to answer the prompt 170 based on the data set 122a. The code or instructions 173 can be expressed in any of a variety of ways, such as one or more SQL statements, as executable or interpretable code, such as Python code, as a list of API calls or commands to be executed, and so on. The code or instructions 173 can provide instructions for retrieving specific portions of one or more data sets, such as from the specific data set 122a specified in the prompt 170 or otherwise indicated to the AI/ML model 132 used. The code or instructions 173 can additionally or alternatively instruct various data processing steps or operations to be performed, including data joins, data aggregations, filtering data, evaluating expressions, creating new metrics and calculating their values, etc.

As an example, the data set 122a can include a table named “sales_table,” where the table has an attribute named “region” representing regions and a metric named “sales_amount” that includes the amount of each sale. The code or instructions 173 generated by the AI/ML model 132 can be a SQL statement such as the one below:

```
SELECT
  region,
  SUM(sales_amount) AS total_sales
FROM
  sales_table
GROUP BY
  region;
```

This example uses an alias “total_sales” for the result of summing sales for each region, to represent the total sales amount for each region after aggregating all the individual sale amounts within each region. The SQL statement here instructs a data processing system to select entries from the table “sales_table” that have the same region identifier value, and create a new “total_sales” value for the sum, resulting in a value of total sales for each different region identifier value. In this example, although the computer system 110 is ultimately generating a visualization for the user 105, the computer system 110 did not request or receive a visualization or a description of a visualization from the AI/ML model 132. Instead, the computer system 110 uses the AI/ML model 132 to generate the code or instructions 173 for data retrieval (e.g., retrieving “sales_amount” values from the “sales_table” table, by region) and data processing (e.g., summing sales amounts for each region) to generate aggregate sales values for the regions. The computer system 110 can then coordinate the actual retrieval and processing of the data using the database system 120 to obtain reliable, accurate values to be shown, without the risk of an AI/ML model losing precision or hallucinating incorrect values. The computer system 110 can also select the appropriate visualization type and visualization properties in a way that produces consistent results, conforms to a visual theme or style, without the probabilistic variations of many AI/ML models.

One advantage of the approach of using the AI/ML models 132 to generate code or instructions 173 is that the AI/ML models 132 can be used for generating visualizations without the need to train the AI/ML models 132 for the function of creating or designing visualizations. Instead, the AI/ML models 132 can learn to provide code or instructions, which is more commonly available and is a more objectively-defined task than generating a visualization, which often has more subjective and aesthetic qualities that may result in inconsistent result. There are also typically many good examples of SQL statements and other code that provide good patterns for an AI/ML model to learn. Obtaining a large number of high-quality examples of data visualizations is more difficult and would often require a large quantity of specialized training data. In addition, unlike examples of code, examples of visualizations would not necessarily provide consistent patterns that would allow a model to reliably learn meaningful representations of data.

In stage (E), the computer system 110 examines the code or instructions 173 from the AI/ML model 132 to determine characteristics of the visualization to be created. For example, a translation module 142 can examine the code or instructions 173 to identify data objects, relationships, and other aspects that can be mapped to features of a visualization. The translation module 142 can specify the characteristics of the visualization, as extracted from or inferred based on the code or instructions 173, in a visualization specification 180, which can indicate any of various features to be shown (e.g., data objects to be retrieved or calculated, visualization type, which data series to be illustrated, independent or dependent variables, data ranges, labels for visualization components, and so on).

In some implementations, the visualization specification 180 includes sufficient information for a data processing system, such as the database system 120, to retrieve and calculate all of the data needed to create a visualization or to refresh the visualization with updated information from the data set 122a. In some cases this includes indicating when new logical objects or new quantities need to be defined. For example, if a visualization would use a new column of data that is not natively stored in the data set 122a but is calculated based on columns of data in the data set 122a, the visualization specification 180 can define this column and specify the operations or expressions used to calculated it. For example, if a visualization involves a “profit” metric not stored in the data set 122a, the visualization specification 180 can define the “profit” value to be a “sales” value minus a “cost” value, where the “sales” and “cost” are values (e.g., attributes or metrics) that are part of the data set 122a. As a result, using the visualization specification 180, the database system 120 would be able to identify the types of data that need to be retrieved and/or calculated and generate those values for the visualization.

For example, the translation module 142 can examine the SQL statement that the AI/ML model 132 provided as the code or instructions 173 to identify data that is retrieved or calculated. The significance of the different types of data referenced can be inferred from the clauses, commands, or operators used in the code or instructions 173. For example, in the example discussed above, the translation module 142 can identify the calculation result “total_sales” as a dependent variable to be illustrated, based on its position following the command “AS” and based on the value being calculated as a result of the “SUM( )” function. The translation module 142 can similarly identify “region” as an independent variable based on its use in the “GROUP BY” clause.

Based on the information extracted from the code or instructions 173, and the data model 147 describing the semantic meanings, data types, and/or relationships of these data objects in the data set 122a, the translation module 142 can select a visualization type, e.g., line graph, bar chart, pie chart, heat map, geographical map, etc. The selection can be based on any of multiple factors, including the number of attributes and metrics referred to (e.g., where some visualization types are better suited for larger numbers of data objects), the number of data series (e.g., line charts can show multiple data series, while a pie chart is better suited for a single group of values), relationships of the data objects (e.g., with line charts and bar charts showing relationships with respect to time better than geographical maps, which show relationships with respect to locations), the semantic meanings of the data objects (e.g., a geographical map being more likely when a city, state, country, or other geographical independent variable is present), and so on.

In this case, the translation module 142 selects a pie chart as an appropriate visualization type. Other types of visualizations could similarly be selected (e.g., bar chart, geographic map, etc.) Because the calculation result is values of “total_sales,” those values are designated to set the relative sizes of the different slices of the pie chart. The values of “total_sales” and “region” in the SQL statement are selected as labels for the slices, so each slice indicates the region identifier and the amount of total sales. The visualization specification 180 includes the various characteristics, parameter values, and relationships determined from analysis of the code or instructions 173. For example, the visualization specification 180 can indicate a pie chart as the type of visualization, the “total_sales” as the quantity defining the pie chart slices, the “total_sales” and “region” values as labels for the pie chart slices, and so on. The visualization specification 180 can also specify other properties that may be selected based on factors or sources other than the content of the code or instructions 173. For example, the computer system 110 can store templates that specify visual properties for layout, formatting, font, size, color, and so on. The style template or visual style used can be selected based on user preferences, a selection for the company or other organization, a style of the current document or project in the user interface 162, a default style, and so on. These visual properties can be included in the visualization specification 180 or the visualization specification 180 can include an identifier or reference (e.g., URL) to a source of style information (e.g., a style template document, a cascading style sheet, etc.).

In stage (F), the computer system 110 coordinates the retrieval of data from the data set 122a that will be shown in the visualization. The computer system 110 uses the code or instructions 173 generated by the AI/ML model 132 in this process and obtains the data from the data set 122a from the database system 120. In some implementations, the computer system 110 uses a data retrieval manager 144 module to examine the code or instructions 173, such as to verify or edit the code or instructions 173 as needed for compatibility or efficient processing by the database system 120. In some cases, the standardized format of the code or instructions 173 allows it to be provided directly to the database system 120 for execution or processing. In other cases, the data retrieval manager 144 may alter the code or instructions 173 or translate the code or instructions 173 to another form. For example, the data retrieval manager 144 can translate a generalized or standardized set of code, such as a SQL statement, into a more specialized or targeted form of data processing instructions 174 that makes use of the specific features of the database system 120. For example, the generated data processing instructions 174 can reference functions, commands, modules, application programming interfaces (APIs), or other features of that database system 120 that may go beyond or may not be supported in the more standardized code or instructions 173.

As another example, although the AI/ML model 132 has the data model 147 for the data set 122a in its context when processing the request 172, the resulting code or instructions 173 may include errors, such as incorrect identifiers for attributes, metrics, data sources, or other references to the data set 122a. Similarly, although the AI/ML model 132 may have a very strong capability for generating SQL content, there may still occasionally be errors in the code or instructions 173. The data retrieval manager 144 can examine and validate the code or instructions 173 to identify and correct errors in the syntax or structure of the SQL statement or other content present, and similarly update references to the data set 122a to generate a set of data processing instructions 174 that can be executed correctly by the database system 120. For example, the computer system 110 may apply a set of rules or validation checks to verify that the code or instructions 173 are valid and appropriate to be executed by the database system 120. For example, the computer system 110 can store rules or heuristics 152 that can evaluate the data processing instructions 174 element by element and/or as a whole to verify and correct the code or instructions 173 if needed before they are sent to the database system 120. In some implementations, the computer system 110 uses the rules or heuristics 152 to convert or transform the code or instructions 173 from one format or type to another.

The computer system 110 and the database system 120 can apply access control policies or customize operation based on the identity or role of the user 105 issuing the prompt 170. As a result, the data processing instructions 174 and other operations performed, and the data used, can be limited to what the user 105 is authorized to access. The computer system 110 can examine the code or instructions 173 to apply access control policies, to ensure that no data that the user 105 is not authorized to access is used. If unauthorized data is referenced, the computer system 110 can modify the code or instructions 173 to remove use of unauthorized data or to replace those references with an authorized set of data. The database system 120 similarly applies access control policies when processing the data processing instructions 174.

In stage (G), the computer system 110 sends the data processing instructions 174 to the database system 120, to instruct the database system 120 to retrieve the data needed to be shown in the visualization. As discussed above, the data processing instructions 174 can include the code or instructions 173, or can include a modified version of the code or instructions 173, such as a version that has been converted or translated to a different form for processing by the database system 120.

In stage (H), the database system 120 retrieves and/or calculates a set of results 176 based on the data processing instructions 174 and sends those results 176 to the computer system 110. For example, in the example of FIG. 1, the results 176 include the values of “total_sales” calculated for each of the regions in the table “sales_table” of the data set 122a.

In stage (1), the computer system 110 combines the retrieved data in the results 176 from the database system 120 with the visualization characteristics specified in the visualization specification 180 to generate visualization data 182 that can be rendered or displayed by the user device 106. The computer system 110 can use a visualization generator 146 module to create the visualization data 182, such as image data, markup language content (e.g., HTML, XML, etc.), or other data that can be rendered or displayed to provide the visualization. For example, from the results 176, the visualization generator 146 can obtain values for “total_sales” for each of multiple regions. Based on the visualization specifications 180, the visualization generator 146 determines that the values should be indicated in a pie chart, and the visualization generator 146 generates the pie chart with layout, style, formatting, and other properties as specified in the visualization specifications 180.

In stage (J), the computer system 110 sends the visualization data 182 to the user device 106 over the network 102, as a response to the user prompt 170.

In stage (K), the user device 106 receives and processes the visualization data 182, and displays a visualization 183 as a rendering of the visualization data 182. As a result, the user interface 162 is updated to show the visualization 183 requested from by the user. The visualization 183 shows accurate values for sales numbers, as determined by the database system 120 using the source data set 122a. In addition, the properties of the visualization 183 (e.g., the visualization type, structure, and visual properties) are set as determined by the computer system 110 based on analysis of the code or instructions 173 specifying data retrieval and data processing to be performed.

FIG. 1B shows another example of the system 100 for generating visualizations using artificial intelligence or machine learning. The example of FIG. 1B shows how the functionality to create a visualization can be used in situations other than with a chatbot interface. For example, an AI/ML model 132 can still be used in the process of generating visualizations, even when the user does not provide a text prompt or text-based request. The example of FIG. 1B includes the same overall functionality as discussed for FIG. 1A, and variations for use in situations other than a chatbot interface are discussed below.

In the example of FIG. 1B, the user device 106 shows a user interface 162a, which includes data from the data set 122a, labeled as “Data Set A.” Rather than enter a text prompt, the user requests a visualization by interacting with a control 163, such as a button to request that a visualization can be created. Generation of a visualization can be invoked in other ways. For example, the computer system user device 106 or the computer system 110 may trigger the creation of a new visualization automatically based on detecting an event or condition, such as in response to a user selecting a data set, applying or editing a filter setting, or performing a particular task or action in the user interface 162a. For example, the computer system 110 may initiate the creation of a new visualization as a recommended or suggested item of content when the user 105 is authoring or editing a document, dashboard, report, or other type of content.

In stage (A), a set of input data 171 is provided from the user device 106 to the computer system 110 to initiate creation of a new visualization. This may include data indicating a user interaction with the control 163. Similarly, the input data 171 can indicate context information or a state of the user interface 162a, such as the data set(s) that are active or selected, particular portions of data sets that are selected or used (e.g., particular logical objects, tables, columns, rows, objects, data types, etc.), filters or other settings that are applied and so on. These indications about the subsets of data sets that are being manipulated or viewed in the interface can signal the current data subset or topics of interest to the user 105 at the present time.

In stage (B), the computer system 110 generates a request 172a to an AI/ML service provider 130 for code or instructions that would retrieve and/or calculate the data to be shown in a visualization. The computer system 110 can analyze the input data 171 to extract information indicating the relevant data items that should be visualized. The computer system 110 can thus determine criteria specifying which portions of data from the data set 122a should be retrieved and express those criteria in the request 172a, in natural language text or in another form. For example, from the input data 171 indicating the recent interactions of the user 105 and the state of the user interface 162a (and/or a document shown on the user interface 162a), the computer system 110 can identify the data set 122a as the data set from which data should be retrieved. The computer system 110 can also identify particular data series or data types to be illustrated based on user selections (e.g., highlighting or limiting a view to certain data types), applied data filter settings, and so on. The computer system 110 can then use this information to generate a request for an AI/ML model 132 to process.

As an example, the request 172a can include a text prompt for an LLM to process. For example, the request 172a can include a prompt such as “Generate a SQL statement to retrieve data from Data Set A for a chart or graph of sales and costs over time.” The identification of “Data Set A” (e.g., data set 122a), as well as the items “sales” and “costs” can be determined from the user selections or filter settings in the user interface 162a that indicate that those data items are of interest. As another example, the computer system 110 may select these items for the request 172a based on stored information indicating preferences of the user 105 or other users that shows that, for the data set 122a or for other data sets having similar properties (e.g., similar types of data, similar semantic meaning of logical objects in a data set), sales and costs over time are frequently selected to be shown in visualizations.

In stage (C), the computer system 110 sends the request 172a to the AI/ML service provider 130.

In stage (D), in response to the request 172a, the AI/ML service provider 130 generates code or instructions 173a using one or more of the AI/ML models 132, and the AI/ML service provider 130 sends the generated code or instructions 173a to the computer system 110. The code or instructions 173a can include a SQL statement or instructions in another standardized form or representation.

As an example, the AI/ML model 132 may provide a response to the request 172a that includes a SQL statement such as the one below:

```
SELECT
  YEAR(sale_date) AS sale_year,
  MONTH(sale_date) AS sale_month,
  SUM(total_sales) AS monthly_sales,
  SUM(total_costs) AS monthly_costs
FROM
  SalesData
GROUP BY
  YEAR(sale_date),
  MONTH(sale_date)
ORDER BY
  YEAR(sale_date),
  MONTH(sale_date);
```

In this example, the data model 147 indicates that the data set 122a includes a table named “SalesData,” which includes an attribute “sale_date” which indicates dates, a metric named “total_sales” including sales amounts, and a metric named “total_costs” that indicates costs. The generated code or instructions 173a specifies to generate total sales per month as values “monthly_sales” and to generate total costs per month as “monthly_costs.” This would generate the data for a time series of costs and sales month by month, which could then be represented in a visualization.

In stage (E), the computer system 110 analyzes the code or instructions 173a to generate a visualization specification 180 that defines the characteristics of the visualization to be generated. In this example, the computer system 110 determines that, based on the code or instructions 173a calling for generation of two data series (e.g., monthly sales and monthly costs) that vary with respect to a common independent variable (e.g., time, in units of months), that a line graph would be an appropriate type of visualization, with sales and costs represented on the vertical axis and time in months represented on the horizontal axis. These visualization characteristics, as well as other properties such as labels and formatting and style parameter values, are saved in the visualization specification 180a.

In stage (F), the computer system 110 analyzes the code or instructions 173a to generate data processing instructions 174a for the database system 120 to execute. For example, the computer system 110 can validate the SQL statement to ensure that references to portions of the data set 122a are correct and that syntax complies with the conventions of the database system 120. Similarly, the computer system 110 can translate or convert the SQL statement to another form or programming language if needed.

In stage (G), the computer system 110 sends the data processing instructions 174a to the database system 120.

In stage (H), the database system 120 generates results by executing or otherwise processing the data processing instructions 174a, and the database system 120 sends the results 176a to the computer system 110. For example, the results 176a can include values calculated from the data set 122a that show the monthly sales and monthly costs as indicated by the code or instructions 173a.

In stage (1), the computer system 110 generates visualization data 182a for a visualization that represents the values in the results 176a with the visual properties specified in the visualization specification 180a.

In stage (J), the computer system 110 sends the visualization data 182a to the user device 106 over the network 102.

In stage (K), the user device 106 receives the visualization data 182a and then renders and displays the visualization data 182a as a visualization 183a in the user interface 162a.

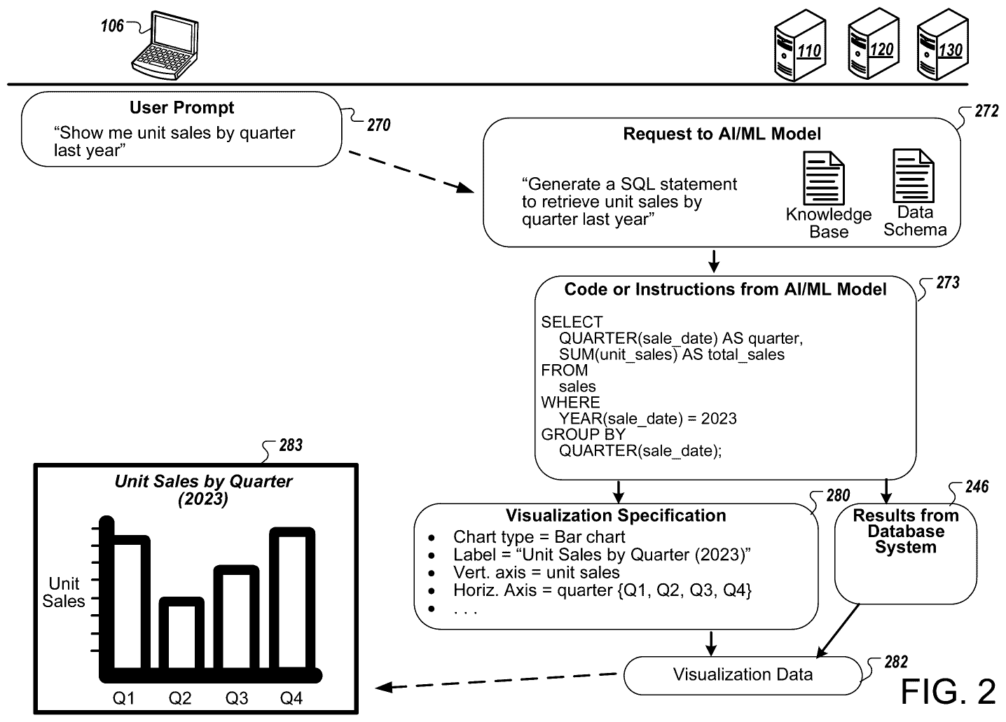

FIG. 2 is a diagram showing another example of generating a visualization using artificial intelligence or machine learning. In the example, a the user 105 submits the user prompt 270 “Show me unit sales by quarter last year.” The computer system 110 receives this prompt 270 from the user device 106, and the computer system 110 generates a request 272 to the AI/ML service provider 130.

The request 272 identifies one or more data sets corresponding to the user prompt 270, such as a data set associated with a chatbot the user 105 is interacting with or a data set associated with a document that is open or active on the user device 106. The request 272 also includes a knowledge base for the user 105 and/or for a company or other organization the user 105 is associated with. The request 272 also includes a data schema for the one or more data sets to be used. The request also includes an instruction for an AI/ML model 132 to generate code or instructions to retrieve the data for the visualization, e.g., “Generate a SQL statement to retrieve unit sales by quarter last year.”

The computer system 110 sends the request 272 to the AI/ML service provider 130 and receives the code or instructions 273 in response. From the code or instructions 273, which in this case is a SQL statement, the computer system 110 extracts information to generate a visualization specification 280. For example, due to four discrete values being calculated with respect to periods of time, the computer system 110 selects a bar chart as an appropriate type of visualization. Based on the calculation of “total_sales” called for by the SQL statement, and its value being a sum of values of “unit_sales,” the computer system specifies that the vertical axis should show unit sales and be labeled accordingly. Similarly, due to the clause indicating to group by quarter, the computer system 110 determines that the horizontal axis should organize values by quarter. Other properties, such as a label for the table as a whole, can similarly be determined, e.g., with the data from “unit_sales” and the data range for the year 2023 being used to define the overall title for the visualization.

In many cases, determining visualization properties from the code or instructions 273 can accurately and consistently determine visualization properties that align with the user's intent, often better than through attempts to determine these properties from user-provided natural language text directly. Some prior systems have attempted to infer visualization types and other visualization properties from natural language. However, the present system can provide more accurate and useful results by leveraging an AI/ML model's natural language processing capability to interpret the user prompt 270 together with the data schema or data model for specified data set(s). The capability is further enhanced by using the AI/ML model 132 to provide output in an output format, such as SQL or another programming language, with standardized or well-defined relationships, which further limits the likelihood of ambiguity in the results, even compared to general prose text outputs of AI/ML models. Finally, by including the knowledge base in the request 172 and context processed by an LLM or other AI/ML model 132, the code or instructions 273 can more accurately interpret both the user prompt 270 and the data schema or data model. For example, the knowledge base can enable the AI/ML model 132 to map terms between the user prompt 270 and the data schema, even if one or both include ambiguous or idiosyncratic terms that would not be known without the knowledge base.

The computer system 110 also generates results 246 from the database system 120, including the values of unit sales by quarter from the one or more data sets specified in the request 272. The computer system uses the visualization specification 280 and the results 246 to generate visualization data 282 that can be rendered or displayed by the user device 106 as the visualization 283.

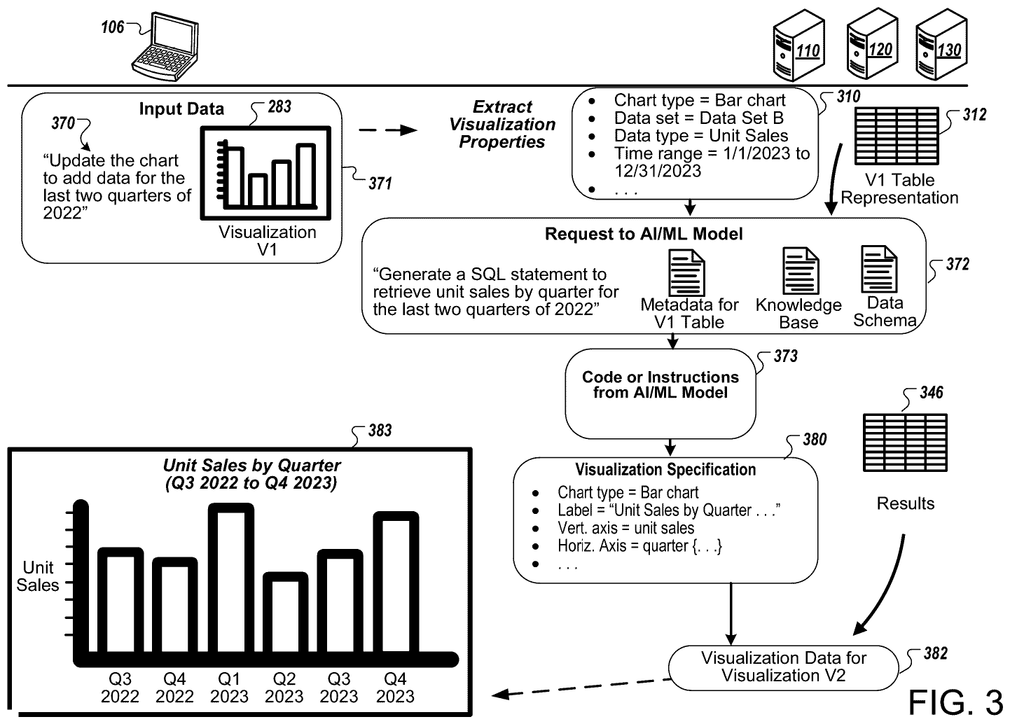

FIG. 3 is a diagram showing another example of generating a visualization using artificial intelligence or machine learning. The example of FIG. 3, shows how an existing visualization can be used as an input to the process of generating a visualization. In this example, the existing visualization 283 created in the example of FIG. 2 is referenced by a user prompt 370, which is an instruction to “Update the chart to add data for the last two quarters of 2022.” The previous interactions in the conversation with the chatbot, e.g., the user's previous prompt 270 and the resulting visualization 283 provided in response, provide the context for the computer system 110 and the AI/ML model 132 to determine that the “chart” referenced is the visualization 283 and the “data” to be added is the type of data shown in the visualization 283 (e.g., unit sales by quarter, from the same data set used to generate the visualization 283). The computer system 110 and/or the AI/ML model 132 can thus infer the interpretation of the terms in the prompt 370 based on the history of the conversation. In other cases, context about the content currently being displayed on a user interface, a data set or document that is active or viewed, a current or recent task or command of the user 105, or other information can additionally or alternatively be used to interpret the instruction of the user 105.

In the example of FIG. 3, the user prompt 370 explicitly refers to a “chart” and this results in using the visualization 283 as an input in the visualization process. This can allow users to alter or change visualizations provided by the computer system 110 or to iteratively build a visualization over a series of multiple interactions. Visualizations can serve as input to the visualization creation process in other ways, even without being explicitly referenced by a user. For example, in some cases a user action (e.g., selecting a button or other control) or a user prompt may call for a visualization without mentioning another visualization, and the computer system 110 may still identify an existing visualization as relevant context to be used. For example, the computer system 110 can infer that an existing visualization is relevant based on the visualization being in the user's recent conversation history with a chatbot or may be shown on a document or user interface at the user's device. In addition, or as an alternative, the computer system 110 can infer that an existing visualization is relevant based on the existing visualization being created from the same data set the user is working with, based on the existing visualization representing a data type or data with the same semantic meaning as a current task or user request, based on common keywords or topics being referenced in the current user request and keywords in the existing visualization or its metadata or the request that prompted creation of the existing visualization, and so on. In some cases, visualizations that other users have created using the same or similar data sets, keywords, topics, and so on may indicate that they are relevant context to serve as input for a new visualization.

In the example of FIG. 3, the user prompt 370 and the existing visualization 283 serve as input data 371 for the creation of a new visualization. The computer system 110 extracts information from the visualization 283, such as a set of visualization properties 310, which can include any of the types of information in a visualization specification, such as visualization type, identification of data series shown, identification of a data source, data ranges represented, precision or granularity, scale, size, formatting, style, and so on. The computer system 110 can also represent the existing visualization 283 as a data table 312, which indicates the types of data and relationships in the visualization 283. In this example, the data table 312 can include a attribute for different quarters of the year 2023 and a metric for unit sales total for each quarter, along with names of the attributes and metrics and potentially other information.

The computer system 110 uses the input data to generate a request 372 to the AI/ML service provider 130, for the AI/ML model 132 to process an instruction to “Generate a SQL statement to retrieve unit sales by quarter for the last two quarters of 2022.” The request 372 can include metadata for the table representation 312 of source visualization 283, e.g., Visualization V1. For example, the metadata for the table representation 312 a data schema or data model for the data represented in the visualization 283. This can include a list or description of the different logical objects (e.g., data objects) that are represented in the visualization 283, allowing the code or instructions 273 to refer to the table 312 and the logical objects it contains. This can allow consistency in allowing subsequent visualizations to refer to the same logical objects and data sets used in the source visualization 283.

The request 372 includes a data schema or data model for the data set to be used, so the generated SQL statement can appropriately reference the logical objects that represent the types of data stored in the tables, columns, and other data elements of the appropriate data set. The request 372 also includes a knowledge base for the user and/or the user's organization to enhance interpretation of the request by the AI/ML model 132. Depending on the implementation, other types of text may be provided in the request. For example, another option is “Generate a SQL statement to retrieve data as requested by the user prompt “Update the chart to add data for the last two quarters of 2022,” from Data Set A.” The request 372 may optionally include the visualization 283, the table 312 of data corresponding to the visualization 283, and/or some or all of the visualization properties 310 extracted from the visualization 283.

The AI/ML service provider 130 sends a response that includes generated code or instructions 373 for retrieving and/or calculating data for the new visualization. For example, the code or instructions 373 can include a SQL statement such as:

```
SELECT
  YEAR(sale_date) AS year,
  QUARTER(sale_date) AS quarter,
  SUM(unit_sales) AS total_sales
FROM
  sales
WHERE
  sale_date >= ‘2022-07-01’ AND sale_date <= ‘2022-12-31’
GROUP BY
  YEAR(sale_date),
  QUARTER(sale_date)
ORDER BY
  YEAR(sale_date) DESC,
  QUARTER(sale_date) DESC;
```

In some implementations, the code or instructions 373 is generated to refer to the table 312, or at least the logical objects of the table 312 that are indicated in the metadata for the table 312 provided to the AI/ML model. For example, the “WHERE” clause of a SQL statement may refer to directly to the table 312 representing the source visualization 283, in order to use the table 312 (and thus filter properties applied for the visualization 283) as filter criteria for the new set of data specified by the code or instructions 373. In the code or instructions 373, references to the table 312 or the visualization 283 in a SQL statement can specify or limit which attributes to retrieve, which metrics to calculate, and/or which filters to apply. By referencing visualizations and tables in this way, the code or instructions 373 can maintain continuity by importing logical object definitions and other criteria (e.g., for filtering, sorting, etc.) from one visualization to the next.

The computer system 110 generates a visualization specification 380 based on the code or instructions 373 generated by the AI/ML model 132. As discussed above, a visualization specification 380 can specify the logical objects to be retrieved and/or calculated from a data set, including any new logical objects to be created (e.g., any new attributes or metrics that are derived from a data set and the equations or expressions used to derive them). The visualization specification 380, like the code or instructions 373, can reference the table 312 representing data in the source visualization 283. At each step in the processing, when generating the request 372 to the AI/ML model 132, in the code or instructions 373, in the visualization specification 380, and when retrieving the results 346, the source visualization 283 or its table representation 312 can serve as criteria for data retrieval, data processing, and data presentation, e.g., as a data filter, as a source of object definitions, and so on.

For example, the table 312 or logical objects corresponding to the table 312 can be used to import or define criteria for manipulating data (e.g., retrieving, calculating, filtering, sorting, etc.). As an example, a source visualization may refer to the top 100 customers, and then a SQL statement generated by the AI/ML model 132 based on the visualization may specify to select data from a set of categories by revenue, where customers are taken from the table representing the source visualization. In effect, the properties of the data of the source visualization is used as a filter for the new visualization, specifying that the data is determined for the top 100 customers represented in the source visualization. The visualization specification for the new visualization can reference the source visualization or its table representation to specify this filter, as well as to define the logical objects and/or data set(s) from which the data is obtained.

When the visualization specification 380 clearly defines logical objects to be used, this helps make visualizations able to be re-created or refreshed. Logical objects of a data set can be referenced directly (e.g., based on the data model or data schema) or indirectly through a table 312 associated with the source visualization 283 (e.g., based on metadata for the table 312). References to these logical objects, and definitions for newly-defined logical objects if needed, allow the database system 120 to retrieve and calculate all the information needed for a visualization. The visualization specification 380 can clearly and fully specify the logical objects to retrieve or calculate, so that the visualization specification 380 does not include or depend on a static data set, but instead allows the data for the visualization to be retrieved fresh from the source data set(s). As a result, after a visualization has been created, if the user wants to update the visualization with the most current data, the user can simply select to refresh the visualization and a new set of updated data can be generated and shown in the visualization.

The computer system 110 also uses the code or instructions 373 to send instructions to the database system 120 to obtain results 346 showing the values to be presented in the new visualization. As discussed above, the visualization specification 380 can include the logical object identification, logical object definitions, references to data sets, references to other tables or visualizations, and so on that are needed to obtain the results 346.

The computer system 110 then uses the visualization specification 380 and the results 346 to generate visualization data 382 for the new visualization 383. For example, based on the data that the visualization specification 380 specifies should be retrieved and calculated, the computer system 110 can obtain the full set of data to be shown in the new visualization, e.g., retrieving again the data the four quarters represented in visualization 283 as well as retrieving the data for the additional two quarters requested in the user prompt 370. In other words, data for the full range is refreshed or retrieved together from the database system 120. The computer system 110 sends the visualization data 382 to the user device 106, which renders the visualization data 382 to present the visualization 383 in response to the user's prompt 370.

A variety of different situations can involve using one or more previous visualizations to create a new visualization. A few examples include adding a data series, combining multiple visualizations together, extending or compressing a range of data, converting from one visualization type to another (e.g., from a pie chart to a bar chart), changing (e.g., adding, removing, or altering) a filter for data in a visualization, replacing one data series with another, changing a scale or size of a visualization, changing a grouping or aggregation of data, creating a visualization that has formatting or style of a previous visualization, or combinations thereof.

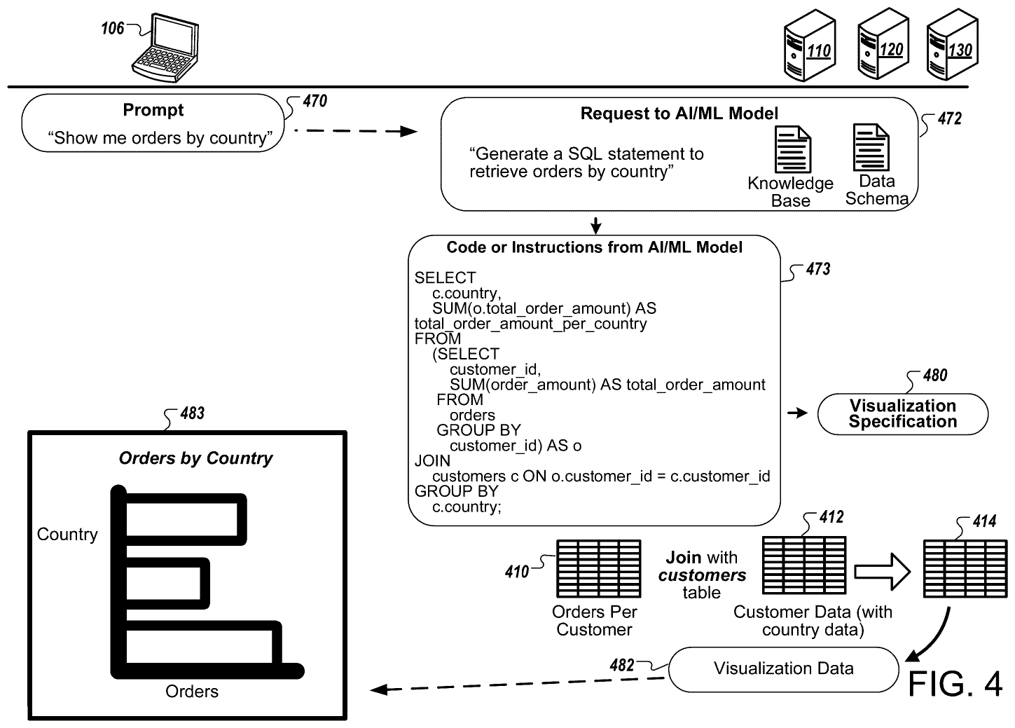

FIG. 4 is a diagram showing another example of generating a visualization using artificial intelligence or machine learning. The example of FIG. 4 shows how the computer system 110 can generate a visualization from multi-step or multi-pass SQL statements, or other sets of code or instructions from an AI/ML model 132 that include multiple stages. The computer system 110 can examine code or instructions from an AI/ML model 132 and detect when a sequence of multiple data processing steps are needed or when temporary or intermediate data sets are generated. The computer system 110 then coordinates with the database system 120 to retrieve and combine the data as specified, and generate the resulting visualization.

For example, a user provides a prompt 470, “Show me orders by country” to a chatbot that has a corresponding data set with order data. The computer system 110 receives the prompt 470 and generates a request 472 to an AI/ML model 132. The request 472 includes the prompt 470, a knowledge base, and a data schema or data model for the data set corresponding to the chatbot. The computer system 110 sends the request 473 to the AI/ML service provider 130, which returns a set of code or instructions 473 generated by an AI/ML model 132.

The computer system 110 examines the code or instructions 473 and determines that multiple steps or stages of processing are called for. For example, the computer system 110 can identify features of SQL commands and syntax that show that multiple passes or stages are used, such as the presence of two “SELECT” commands indicating two data retrieval operations, the presence of a “JOIN” command to indicate joining of two tables or data sets, the grouping of a set of commands nested in parentheses, and/or the labeling of a retrieved subset of data (e.g., the data referred to as “o”) as a temporary table or other data structure. These aspects and/or other keywords, phrases, patterns, syntax, structure, or other features can be detected by the computer system 110 to detect the presence of multiple stages of data retrieval and data processing, as well as to separate out the different processing steps.

In the example, the code or instructions 473 include a SQL statement:

```
SELECT
  c.country,
  SUM(o.total_order_amount) AS total_order_amount_per_country
FROM
  (SELECT
    customer_id,
    SUM(order_amount) AS total_order_amount
  FROM
    orders
  GROUP BY
    customer_id) AS o
JOIN
  customers c ON o.customer_id = c.customer_id
GROUP BY
  c.country;
```

This example includes a first step of processing to generate a set of order totals for each customer (e.g., for each customer_id value) represented as table “o,” and a second step of processing to sum the customer order totals by country to obtain a set of set of total orders per country.

From the code or instructions 473, the computer system 110 extracts information to create a visualization specification 480. The computer system 110 also coordinates data retrieval and processing based on the code or instructions 473. This involves sending instructions to the database system 120 to create a first table 410 indicating orders per customer, then join it with a second table 412 that indicates the country of each customer, so a final table 414 indicating the amount of orders per country can be determined.

The computer system 110 then uses the visualization specification 480 and the table 414, which includes the result of all of the multiple steps of data retrieval or data processing, to generate the visualization data 482, which the computer system 110 sends to the user device 106. The user device renders the visualization data 482 and displays the visualization 483 as a response to the prompt 470.

In some implementations, the computer system 110 creates a table and/or visualization for each step or stage of data processing indicated by the code or instructions 473. For example, by creating and storing a temporary table and temporary visualization for each stage, as an intermediate processing step, the computer system 110 may leverage existing procedures and modules that create a table and visualization for a single stage. In addition, having intermediate tables and/or visualizations for the components of the final visualization 483 can be useful to show the user 105 how the prompt 470 was interpreted and how the system arrived at the data in the visualization 483. Temporary tables and temporary visualizations for intermediate steps may be hidden from the user, at least initially, and then can be made available if a user requests to view them or enables a view of them (e.g., by clicking a user interface control to show a hidden region, to expand a user interface panel, etc.).

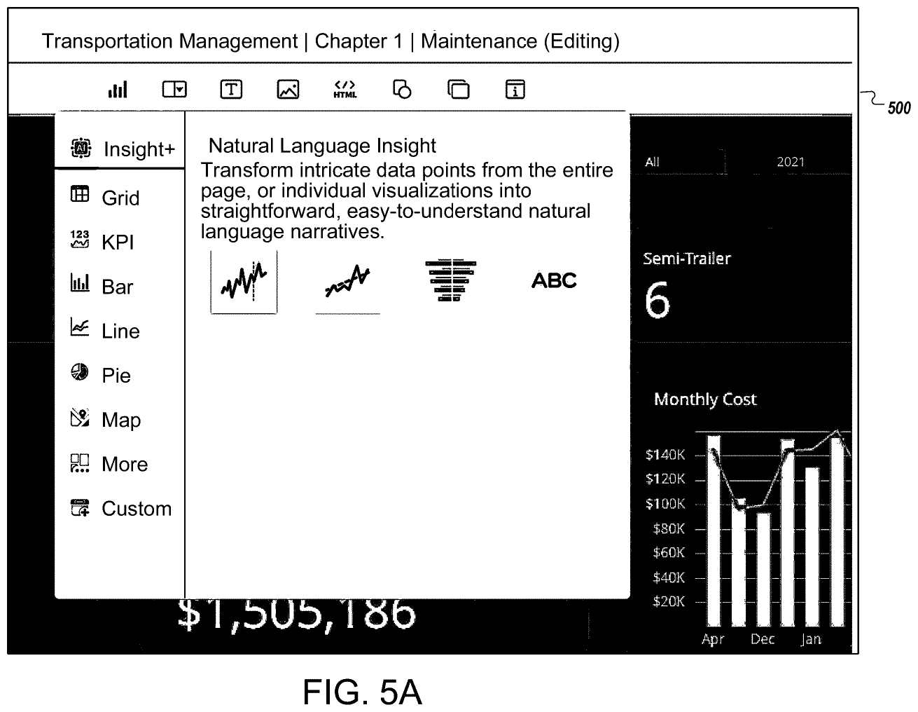

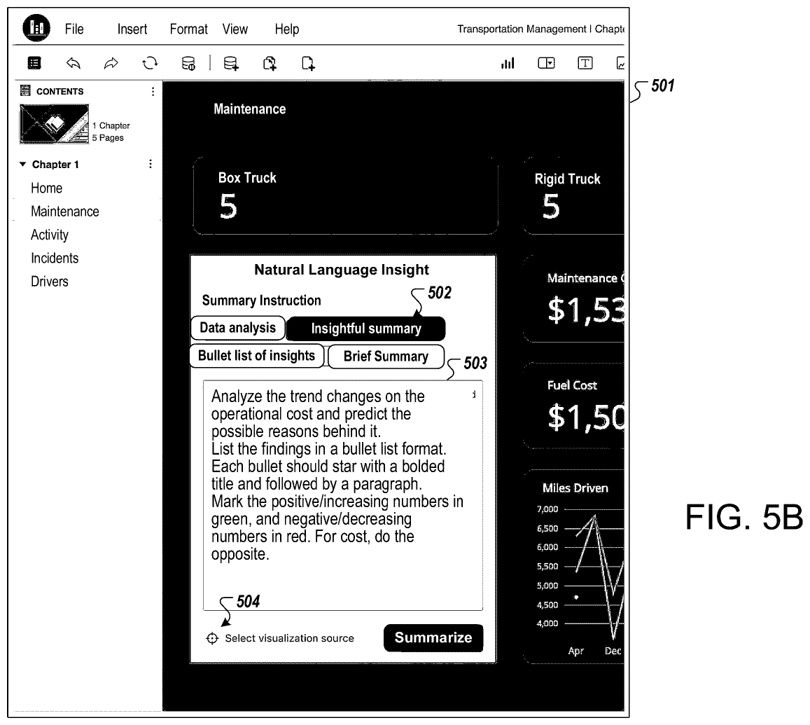

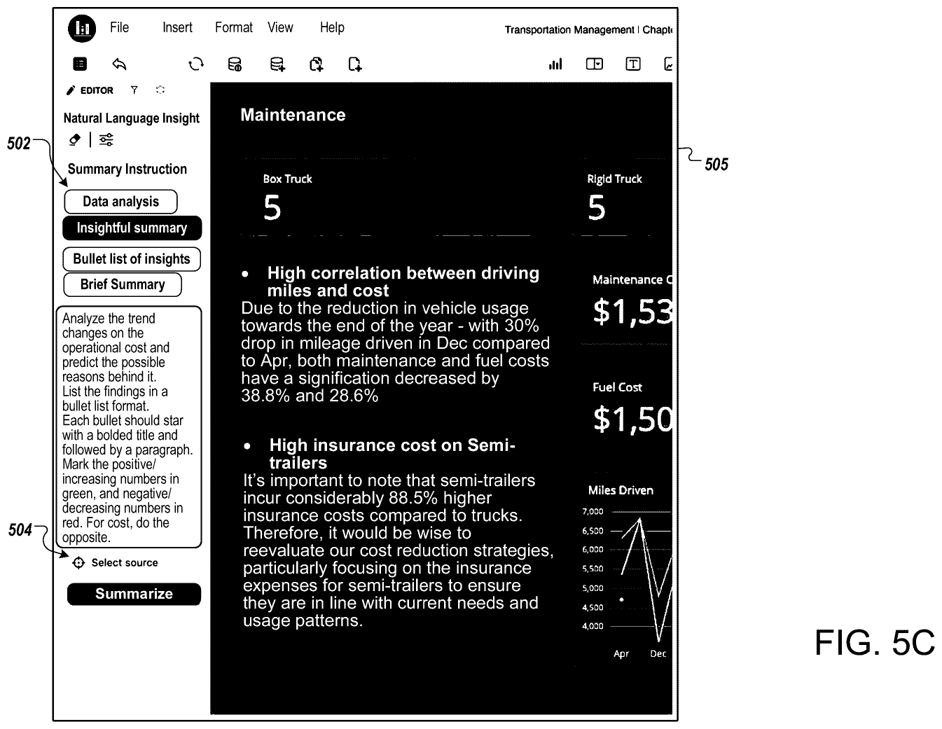

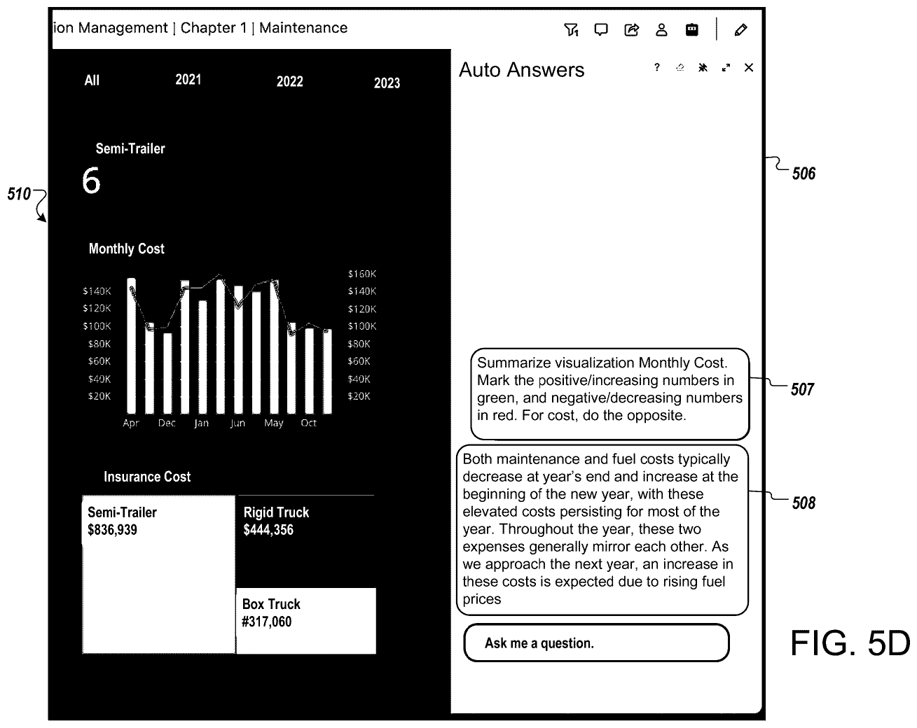

FIGS. 5A-5D show example user interfaces showing functionality for showing natural language insight derived from visualization data and other content.

FIG. 5A shows an example how the system can provide a user an interface to obtain natural language summaries or insights from other content, whether the content was generated with an AI/ML model or generated in another form. The functionality can use an LLM or other model to convert complex dashboard data into clear, natural language narratives. The information is generated based on the current context, e.g., the current page or view of a document being viewed or edited, or the context of a chatbot conversation. The system can tailor narratives to the viewer's role and context, ensuring they see the most relevant insights for their decisions. When generating the natural language information, the source material can vary according to the user's needs, to create narratives from an entire dashboard, a specific page, or selected visualizations.

FIG. 5B shows another example user interface 501 that shows how the natural language narratives or insights can be created. The user interface 501 shows multiple different types of natural language content that can be generated, such as data analysis, insightful summary, bullet list of insights, or brief summary. For each of these options, the system stores a predetermined instruction to an AI/ML model 132. Each of these options is represented as a interactive user interface element 502, and when the user selects one of the UI elements 502, the text field 503 below is populated with the instruction to be provided to the AI/ML model 132. This provides the user the ability to see and potentially edit what will be requested, and how the different types of summaries differ from each other. The user interface 501 also includes a control 504 to select a visualization source, so the user can specify specific data to be summarized, such as a specific visualization, a page of a document, a dashboard, and so on.

FIG. 5C shows another example user interface 505 that provides the UI elements 502 representing different types of summary instructions that populate the text field 503 to be viewed. The user has selected the Insightful Summary option, which includes an instruction, “Analyze the trend changes on the operational cost and predict the possible reasons behind it. List the findings in a bullet list format. Each bullet should start with a bolded title followed by a paragraph. Mark the positive slash increasing numbers in green, and negative slash decreasing numbers in red. For cost, do the opposite.” In response, the system has provided the summary in the area to the right, with a bullet list format and color coding of metric values as requested. The data being summarized is taken from the current document, such as the data being visualized in one or more visualizations.

FIG. 5D shows an example user interface 506 of a summary response showing a natural language summary 508 of the visualization 510 in a document. The user selected the visualization titled “Monthly Cost,” and selected the “Brief Summary” option. This provided an instruction, “summarize visualization monthly cost. Mark the positive/increasing numbers in green and negative/decreasing numbers in red. For cost, so the opposite.” The computer system 110 sends the instruction, along with the visualization data (e.g., table of data being visualized, visualization specification, data model or data schema for the related data set(s), etc.) to the AI/ML model 132 to be processed. The system 110 provides the response 508 generated by the AI/ML model 132, “Both maintenance and fuel costs typically decrease at year's end and increase at the beginning of the new year, with these elevated costs persisting for most of the year. Throughout the year, these two expenses generally mirror each other period as we approach the next year, an increase in these costs is expected due to rising fuel prices.” Although an LLM typically you cannot read visual data or image content, the computer system 110 provides the LLM the data series for results that are represented in the visualization, along with the metadata, semantic information, data model, and other context needed to interpret the values provided. As a result, the AI/ML model is able to provide summary natural language information according to the instruction, based on existing data sets and visualizations.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

1. A method performed by one or more computers, the method comprising:
identifying, by the one or more computers, a data source with which to generate a visualization and one or more criteria for selecting data from the data source to be represented in the visualization;
generating, by the one or more computers, a request for an artificial intelligence or machine learning (AI/ML) model to generate code or instructions to retrieve from the data source data that satisfies the one or more criteria;
sending, by the one or more computers, the request to be processed by the AI/ML model;
receiving, by the one or more computers, code or instructions that the AI/ML model generated in response to the request;
determining, by the one or more computers, one or more visualization properties for the visualization based on the code or instructions that the AI/ML model generated in response to the request; and
providing, by the one or more computers, visualization data for display, wherein the visualization data is displayable to present data retrieved from the data source based on the code or instructions that the AI/ML model generated, with the retrieved data being presented according to the one or more visualization properties determined based on the code or instructions that the AI/ML model generated.

2. The method of claim 1, wherein the request is a request for a large language model (LLM) to generate a structured query language (SQL) statement;
wherein the received code or instructions comprises a generated SQL statement; and
wherein the one or more parameters for the visualization are determined based on analysis of the SQL statement.

3. The method of claim 1, wherein the one or more criteria comprises a user prompt comprising text that includes a natural language statement from a user; and
wherein generating the request comprises generating a request to generate code or instructions to retrieve and/or calculate values specified by the natural language statement in the user prompt.

4. The method of claim 3, wherein the user prompt is input to a chatbot and the visualization data is provided as output of the chatbot in response to the user prompt.

5. The method of claim 1, wherein the one or more criteria comprises information derived from an existing visualization.

6. The method of claim 1, wherein the one or more criteria includes one or more criteria determined based on a document or user interface that is active on a client device.

7. The method of claim 1, comprising translating the code or instructions generated by the AI/ML model to a set of data processing instructions for a database system; and
retrieving the data represented in the visualization from the database system based on the generated data processing instructions.

8. The method of claim 1, wherein the visualization properties determined based on the code or instructions from the AI/ML model specify at least one of a visualization type, a label for the visualization or a portion of the visualization, a data series to be represented in the visualization, a layout of the visualization, or formatting of the visualization.

9. The method of claim 1, wherein the data source comprises one or more data tables, and wherein the code or instructions specify one or more rows of data to retrieve and calculations using data from the one or more rows that generate values to be represented in the visualization.

10. The method of claim 1, wherein the request includes a data model or data schema for the data source; and
wherein the code or instructions generated by the AI/ML model includes instructions, using references to data elements specified in the data model or data schema, to retrieve a particular subset of data from the data source that satisfies the particular set of criteria.

11. A system comprising:
one or more computers; and
one or more non-transitory computer-readable media storing instructions that are operable, when executed by the one or more computers, to cause the one or more computers to perform operations comprising:
identifying, by the one or more computers, a data source with which to generate a visualization and one or more criteria for selecting data from the data source to be represented in the visualization;
generating, by the one or more computers, a request for an artificial intelligence or machine learning (AI/ML) model to generate code or instructions to retrieve from the data source data that satisfies the one or more criteria;
sending, by the one or more computers, the request to be processed by the AI/ML model;
receiving, by the one or more computers, code or instructions that the AI/ML model generated in response to the request;
determining, by the one or more computers, one or more visualization properties for the visualization based on the code or instructions that the AI/ML model generated in response to the request; and
providing, by the one or more computers, visualization data for display, wherein the visualization data is displayable to present data retrieved from the data source based on the code or instructions that the AI/ML model generated, with the retrieved data being presented according to the one or more visualization properties determined based on the code or instructions that the AI/ML model generated.

12. The system of claim 11, wherein the request is a request for a large language model (LLM) to generate a structured query language (SQL) statement;
wherein the received code or instructions comprises a generated SQL statement; and
wherein the one or more parameters for the visualization are determined based on analysis of the SQL statement.

13. The system of claim 11, wherein the one or more criteria comprises a user prompt comprising text that includes a natural language statement from a user; and
wherein generating the request comprises generating a request to generate code or instructions to retrieve and/or calculate values specified by the natural language statement in the user prompt.

14. The system of claim 13, wherein the user prompt is input to a chatbot and the visualization data is provided as output of the chatbot in response to the user prompt.

15. The system of claim 11, wherein the one or more criteria comprises information derived from an existing visualization.

16. The system of claim 11, wherein the one or more criteria includes one or more criteria determined based on a document or user interface that is active on a client device.

17. The system of claim 11, comprising translating the code or instructions generated by the AI/ML model to a set of data processing instructions for a database system; and
retrieving the data represented in the visualization from the database system based on the generated data processing instructions.

18. The system of claim 11, wherein the visualization properties determined based on the code or instructions from the AI/ML model specify at least one of a visualization type, a label for the visualization or a portion of the visualization, a data series to be represented in the visualization, a layout of the visualization, or formatting of the visualization.

19. The system of claim 11, wherein the data source comprises one or more data tables, and wherein the code or instructions specify one or more rows of data to retrieve and calculations using data from the one or more rows that generate values to be represented in the visualization.

20. One or more non-transitory computer-readable media storing instructions that are operable, when executed by one or more computers, to cause the one or more computers to perform operations comprising:
identifying, by the one or more computers, a data source with which to generate a visualization and one or more criteria for selecting data from the data source to be represented in the visualization;
generating, by the one or more computers, a request for an artificial intelligence or machine learning (AI/ML) model to generate code or instructions to retrieve from the data source data that satisfies the one or more criteria;
sending, by the one or more computers, the request to be processed by the AI/ML model;
receiving, by the one or more computers, code or instructions that the AI/ML model generated in response to the request;
determining, by the one or more computers, one or more visualization properties for the visualization based on the code or instructions that the AI/ML model generated in response to the request; and
providing, by the one or more computers, visualization data for display, wherein the visualization data is displayable to present data retrieved from the data source based on the code or instructions that the AI/ML model generated, with the retrieved data being presented according to the one or more visualization properties determined based on the code or instructions that the AI/ML model generated.
